(19) United States
(12) Patent Application Publication
(10) Pub. No.: US 2016/0320617 A1
(43) Pub. Date: Nov. 3, 2016

(54) Head-Up Display Device

(71) Applicant: Yazaki Corporation, Tokyo (JP)

(72) Inventor: Junichi Matsushita, Susono-shi (JP)

(73) Assignee: Yazaki Corporation, Tokyo (JP)

(21) Appl. No.: 15/205,242

(22) Filed: Jul. 8, 2016

Related U.S. Application Data
(63) Continuation of application No. PCT/JP2015/053868, filed on Feb. 12, 2015.

(30) Foreign Application Priority Data
Feb. 13, 2014 (JP) 2014-025428

(51) Int. Cl. G02B 27/01; G02B 27/14

(52) U.S. Cl. CPC G02B 27/0101; G02B 27/141; G02B 2027/0145

(57) ABSTRACT

There is provided an HUD apparatus including: a display device that is provided inside a vehicle interior and projects display light, and a reflective member that is provided on an instrument panel, has retroreflectivity, reflects the display light projected from the display device, and guides the display light to a windshield. The display device is disposed at outside of the instrument panel in the vehicle interior.

### CROSS REFERENCE TO RELATED APPLICATIONS

This application is a continuation of PCT application No. PCT/JP15/053868, which was filed on Feb. 12, 2015 based on Japanese Patent Application (No. 2014/025428) filed on Feb. 13, 2014, the contents of which are incorporated herein by reference.

### BACKGROUND OF THE INVENTION

1. Field of the Invention

The present invention relates to a head-up display apparatus.

2. Description of the Related Art

In the related art, a head-up display apparatus (hereinafter, also referred to as an HUD apparatus, in some cases), which is mounted in a vehicle so as to be used, has been known (for example, see PTLs 1 and 2).

For example, in the HUD apparatus, display light projected from a display device is guided to the windshield through a reflective member or the like, and the display light reflected from the windshield is visually recognized by a driver. In the HUD apparatus, since a display image as a virtual image is formed at a position in front of the windshield in a traveling direction (that is, backward in a visual-recognition direction of the driver), it is advantageous that the driver completes, in a short time, focusing required for visual recognition of a display image. In addition, according to the HUD apparatus, since it is possible to visually recognize the display image formed in front of the windshield in the traveling direction by superimposing the image on a sight in front of the vehicle that is recognized through the windshield, it is possible to present information in a new mode different from a display performed by using a common display panel. Further, as a reflective surface of the display light, an optical member (half mirror), which is referred to as a combiner, is used in some cases, instead of the windshield.

[PTL 1] JP-A-2012-203090

[PTL 2] Japanese Patent No. 4928014

### SUMMARY OF THE INVENTION

The HUD apparatus illustrated in FIG. 1 in PTL 1 includes a display device, a concave mirror, a concave lens, a windshield, an operational switch, and a control device. Here, the display device, the concave mirror, the concave lens, and the control device are accommodated in a space demarcated in the inside of the instrument panel.

However, in such a configuration, the respective members need to be provided so as to avoid interfering with a structural body or a functional component (for example, a meter unit, an air-conditioning pipe, or the like) disposed inside the instrument panel, and thus, it is difficult to satisfy mounting conditions in some cases.

In addition, PTL 2 discloses an HUD apparatus that uses a reflective member having retroreflectivity. In the HUD apparatus, respective members are disposed in the vehicle interior. However, in the HUD apparatus, a large-sized combiner or cylinder is used as a component, and thus, such it is difficult to mount such a component in an actual vehicle.

The present invention is made in view of these circumstances, and thus, an object thereof is to provide a head-up display apparatus which is improved in mountability.

In order to achieve the object described above, a head-up display apparatus according to the present invention is characterized by the following features.

(1) The head-up display apparatus includes: a display device that is provided inside a vehicle interior and projects display light; and a reflective member that is provided on an instrument panel, has retroreflectivity, and reflects the display light projected from the display device so as to guide the display light to a windshield or a combiner, wherein the display device is disposed at outside of the instrument panel in the vehicle interior.

The head-up display apparatus according to (1) above is configured to include the display device provided inside the vehicle interior and the reflective member provided on the instrument panel such that no member is disposed inside the instrument panel. Therefore, it is possible to reduce occurrence of interference of the members with a structural body or a functional component which is disposed inside the instrument panel and thus, it is possible to improve mountability.

In addition, in the head-up display apparatus according to (1) above, since it is possible to provide the reflective member substantially over the entire instrument panel, it is possible to use a large-sized reflective member (that is, large reflective surface in horizontal and vertical directions). In this manner, it is possible to realize a display having a wide perspective and it is possible to present information in a wide region of the windshield or the combiner.

(2) In the head-up display apparatus according to (1) above, the display device may be a display device that projects light having a certain wavelength band, and the reflective member or either the windshield or the combiner may reflect only light having the wavelength band.

Incidentally, in the head-up display apparatus, in some cases, sunlight transmitted through the windshield or the combiner is concentrated on the display device via a route reverse to an optical path from the display device to the windshield or the combiner. There is a concern that the concentration of the sunlight will have an adverse effect on the display device or an element disposed on the periphery thereof due to a temperature increase.

In this respect, in the head-up display apparatus according to (2) above, since the reflective member or either the windshield or the combiner reflects only light having the certain wavelength band (for example, visible light band) which is projected from the display device, it is possible to reduce light having a band other than the visible light band of the sunlight from reaching the display device and it is possible to prevent the adverse effect on the display device or the like. In addition, since the reflection ratio from the reflective member or either the windshield or the combiner is improved, it is possible to improve display efficiency.

According to the present invention, it is possible to provide a head-up display apparatus which is improved in mountability.

As above, the present invention is briefly described. Further, the following description of embodiments of the invention is read through with reference to the accompanying drawings and thereby, the details of the present invention will become clearer.

### BRIEF DESCRIPTION OF THE DRAWINGS

FIG. 1 is a side view schematically illustrating a configuration and a disposition of an HUD apparatus according to an embodiment.

FIG. 2 is a side view schematically illustrating a configuration and a disposition of an HUD apparatus according to a modification example.

### DETAILED DESCRIPTION OF THE EXEMPLARY EMBODIMENTS

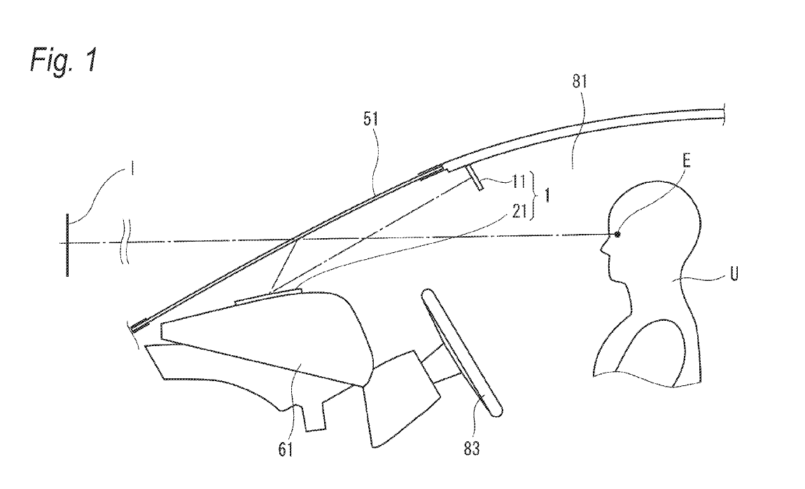

Hereinafter, an embodiment of the present invention will be described with reference to FIG. 1.

A head-up display apparatus (hereinafter, also referred to as an HUD apparatus in some cases) 1 according to the embodiment is used and mounted in a common vehicle. FIG. 1 illustrates the interior of a vehicle, and it is assumed that a driver U sits in a vehicle interior 81 separated from the outside by a windshield 51. An instrument panel 61, in which a steering wheel 83 or the like is provided, is disposed in front of the driver U.

As illustrated in FIG. 1, the HUD apparatus 1 includes, as main configuration, a display device 11 and a reflective member 21. The display device 11 is fixed to a portion of a vehicle body panel that corresponds to a ceiling of the vehicle interior, and is disposed at an obliquely upper position in front of the driver U in the vehicle interior 81. The display device 11 is disposed at outside of the instrument panel 61 in the vehicle interior 81. The reflective member 21 is disposed on the instrument panel 61 along the top surface of the instrument panel 61. Further, similar to an HUD apparatus in the related art, the HUD apparatus 1 actually includes, as another configuration, a control device, an operation switch, or the like, which controls the display device 11; however, the member is not shown in FIG. 1 for simplicity of description.

Schematically, in the HUD apparatus 1, display light projected from the display device 11 is subjected to retroreflection on the reflective member 21 disposed on the instrument panel 61 so as to be guided to the windshield 51, and the driver U visually recognizes the display light reflected from the windshield 51. In the HUD apparatus 1, a display image as a virtual image is formed at a position in front of the windshield 51 in a traveling direction (that is, backward in a visual-recognition direction). In addition, since the windshield 51 transmits light incident thereto from the front side of the vehicle, the driver can visually recognize a sight in front of the vehicle through the windshield 51. In other words, the driver can visually recognize the display image formed in front of the windshield in the traveling direction, which is superimposed on the sight in front of the vehicle.

The display device 11 is, for example, a liquid crystal projector, and projects, toward the reflective member 21 on the instrument panel 61, display light containing a display image for being visually recognized by the driver in response to instruction from the control device not illustrated.

The reflective member 21 is, for example, a film having retroreflectivity, and is attached on the instrument panel 61. The reflective member 21 is an optical member for reflecting the display light projected from the display device 11, and for guiding the display light to the windshield 51. Here, the retroreflectivity is different from normal specular reflection or diffuse reflection, and is a property of reflecting incident light back in the same direction as the direction in which the incident light comes. The reflective member 21 has such retroreflectivity, and, as illustrated in FIG. 1, reflects the light from the display device 11 toward the windshield 51 positioned on the display device 11 side. Since it is possible to provide the reflective member 21 substantially over the entire instrument panel 61, it is possible to use a large-sized member (that is, large reflective surface in horizontal and vertical directions) as the reflective member 21.

Further, in order to add a property of transmitting only light having a certain narrow band of wavelength to a region of the windshield 51 including at least a reflective portion, the region is subjected to dichroic mirror processing. In this manner the display light from the display device 11 is prevented from radiating to the outside.

The HUD apparatus 1 described above is configured to include the display device 11 provided inside the vehicle interior 81 and the reflective member 21 provided on the instrument panel 61, such that no member is disposed inside the instrument panel 61. Therefore, it is possible to reduce occurrence of interference of the members with a structural body or a functional component which is disposed inside the instrument panel 61 and thus, it is possible to improve mountability.

In addition, according to the HUD apparatus 1, since it is possible to provide the reflective member 21 over substantially over the entire instrument panel 61, it is possible to use a large-sized member (that is, large reflective surface in horizontal and vertical directions) as the reflective member 21. In this manner, it is possible to realize a display having a wide perspective and it is possible to present information in a wide region of the windshield 51.

### First Modification Example

First, a problem to be solved by the first modification example is described. In the HUD apparatus 1, in some cases, sunlight transmitted through the windshield 51 is concentrated on the display device 11 via a route reverse to an optical path from the display device 11 to the windshield 51. There is a concern that the concentration of the sunlight will have an adverse effect on the display device 11 or an element disposed on the periphery thereof due to a temperature increase.

Therefore, in the HUD apparatus according to the first modification example, a laser projecting type display device, which projects light having a certain narrow wavelength band, is used as the display device 11, and the windshield 51 is subjected to band-stop filter processing so as to reflect only light having the narrow wavelength band. The laser projecting type display device realizes a full-color display with the display light having respective narrow wavelength bands of RGB. The windshield 51 reflects only light having the narrow wavelength band. Hence, it is possible to reduce the amount of the sunlight reaching the display device 11 and it is possible to prevent the adverse effect on the display device 11 or the like.

### Second Modification Example

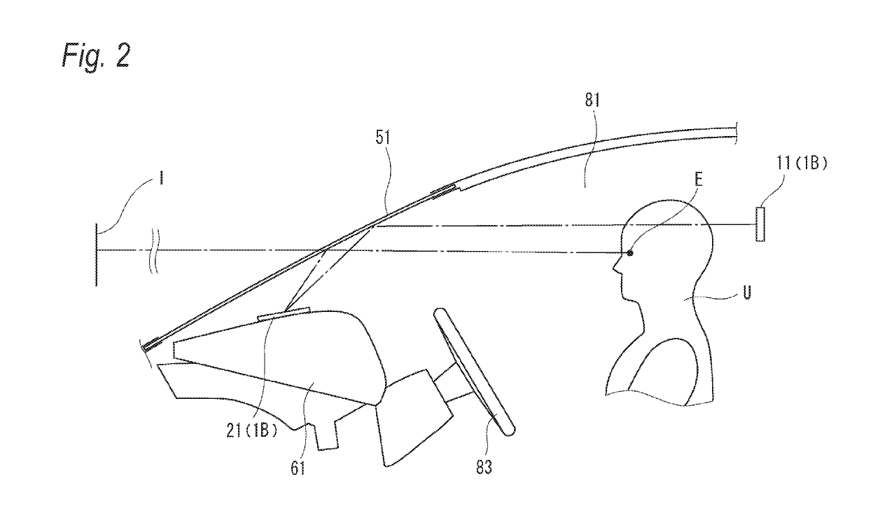

As illustrated in FIG. 2, in an HUD apparatus 1B according to the second modification example, the display device 11 is provided on the rear side of the driver U. More specifically, the display device 11 is provided, for example, on a headrest (not illustrated) of a driver seat. Except for that, the HUD apparatus is the same as the HUD apparatus 1 according to the embodiment described above, thus, the same reference numbers are assigned to the same members, and description thereof is omitted. In this manner, when the display device 11 is configured to be provided inside the vehicle interior 81 and to project display light to the reflective member 21 provided on the instrument panel 61, it is possible to reduce occurrence of interference of the members with a structural body or a functional component which is disposed inside the instrument panel 61 and thus, it is possible to improve mountability, because no member is disposed inside the instrument panel 61.

A technical scope of the present invention is not limited to the embodiments described above. The embodiments described above can be altered or modified in various ways within the technical scope of the present invention.

For example, a configuration may be employed, in which an optical member such as a Fresnel mirror having a magnification effect is embedded in a region of the windshield 51 which reflects the display light, and the display light is magnified on and reflected from the windshield 51. According to the configuration, it is possible to realize a display having a wider perspective.

In addition, in the present invention, an example, in which the driver U visually recognizes the display light reflected from the windshield 51, is described; however, a configuration may be employed, in which a plate-shaped combiner (not illustrated) is used instead of the windshield 51.

Here, features of the HUD apparatus according to the present invention described above is concisely summarized in a list of the following [1] and [2].

[1] The HUD apparatus 1 or 1B according to an embodiment includes: the display device 11 that is provided inside the vehicle interior 81 and projects display light; and the reflective member 21 that is provided on the instrument panel 61, has retroreflectivity, and reflects the display light projected from the display device 11 so as to guide the display light to the windshield 51 or the combiner. The display device 11 is disposed at outside of the instrument panel 61 in the vehicle interior 81.

[2] In the HUD apparatus 1B according to the second modification example, the display device 11 may be a display device that projects light having the certain wavelength band, and the reflective member 21 or either the windshield 51 or the combiner reflects only the light having the wavelength band.

The present invention is described in detail with reference to a specific embodiment; however, it is clear for those skilled in the art that it is possible to perform various alterations or modifications without departing from the spirit and range of the present invention.

According to the present invention, an effect that mountability can be improved is achieved. The present invention, which achieves the effect, is applicable to a head-up display apparatus.

What is claimed is:

1. A head-up display apparatus comprising:
a display device that is provided inside a vehicle interior and projects display light; and
a reflective member that is provided on an instrument panel, has retroreflectivity, and reflects the display light projected from the display device so as to guide the display light to a windshield or a combiner,
wherein the display device is disposed at outside of the instrument panel in the vehicle interior.

2. The head-up display apparatus according to claim 1,
the display device is a display device that projects light having a certain wavelength band, and
the reflective member or either the windshield or the combiner reflects only light having the wavelength band.
